(19) United States
(12) Patent Application Publication
(10) Pub. No.: US 2016/0330217 A1
(43) Pub. Date: Nov. 10, 2016

(54) SECURITY BREACH PREDICTION BASED ON EMOTIONAL ANALYSIS

(71) Applicant: DELL PRODUCTS L.P., Round Rock, TX (US)

(72) Inventor: Carrie Elaine Gates, Livermore, CA (US)

(73) Assignee: DELL PRODUCTS L.P., Round Rock, TX (US)

(21) Appl. No.: 14/705,097

(22) Filed: May 6, 2015

(51) Int. Cl. H04L 29/06

(52) U.S. Cl. CPC H04L 63/1416; H04L 63/20; H04L 63/08; H04L 63/1433; H04L 63/1441

(57) ABSTRACT

Various embodiments of the invention allow to detect and protect against a security breach on a computing system carried out by insiders. In certain embodiments, protection is provided by a security system that monitors and analyzes user activity, estimates emotional states of users, and determines the likelihood of an attack. Based on the analysis an appropriate security response is initiated.

### BACKGROUND

A. Technical Field

The present invention relates to computer security systems and, more particularly, to systems, devices, and methods of detecting and preventing insider attacks on a computing system.

B. Background of the Invention

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use, such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Organizational computer security systems are typically designed with a secure perimeter that protects against attacks initiated from outside the perimeter. However, users internal to that perimeter once successfully authenticated (e.g., by logging in) operate under relatively relaxed security measures since these users are considered to be trusted insiders. Unfortunately, not every insider is trustworthy, and there have been occasions where insiders have performed malicious actions, such as stealing confidential information or purposefully installing malware on a computer system. Given insiders' credentials and access, actions by an insider that are directed against the interests of the organization are oftentimes detected too late, if at all. Therefore, it would be desirable to predict or timely detect a potential attack on a computing system by an untrustworthy insider and take appropriate action in order to prevent or mitigate a security breach.

### BRIEF DESCRIPTION OF THE DRAWINGS

Reference will be made to embodiments of the invention, examples of which may be illustrated in the accompanying figures. These figures are intended to be illustrative, not limiting. Although the invention is generally described in the context of these embodiments, it should be understood that this is not intended to limit the scope of the invention to these particular embodiments.

FIGURE (“FIG.”) 1 is an exemplary block diagram of a security device to detect potential security policy violations, according to various environment of the invention.

FIG. 2 is as flowchart of an illustrative process for detecting potential security policy violations in accordance with various embodiments of the invention.

FIG. 3 is an exemplary block diagram of a security system to detect potential security policy violations, according to various embodiments of the invention.

FIG. 4A is as flowchart of an illustrative process for applying a security response to detecting a potential security policy violation, according to various embodiments of the invention.

FIG. 4B is as flowchart of an illustrative process for applying a security response to detecting potential collusion activity among users, according to various embodiments of the invention.

FIG. 5 depicts a simplified block diagram of an information handling system comprising a security system, according to various embodiments of the present invention.

### DETAILED DESCRIPTION OF THE PREFERRED EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method on a tangible computer-readable medium.

Components, or modules, shown in diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” or “communicatively coupled” shall be understood to include direct connections, indirect connections through one or more intermediary devices, and wireless connections.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated. Furthermore, the use of memory, database, information base, data store, tables, hardware, and the like may be used herein to refer to system component or components into which information may be entered or otherwise recorded.

Furthermore, it shall be noted that: (1) certain steps may optionally be performed; (2) steps may not be limited to the specific order set forth herein; (3) certain steps may be performed in different orders; and (4) certain steps may be done concurrently.

FIG. 1 is an exemplary block diagram of a security device to detect potential security policy violations, according to various environment of the invention. Security device 100 comprises emotions monitor 104, activity monitor 106, and security monitor 110. In embodiments, emotions monitor 104 and/or activity monitor 106 are coupled to security monitor 110. In embodiments, emotions monitor 104 is any device that monitors a condition of a user of a computing system. For example, emotions monitor 104 may be an integrated audio and high-speed video monitoring system that utilizes face analysis software, such as InSight SDK by Sightcorp of Amsterdam, NL, nViso by Nviso SA of Lausanne, Switzerland or Affdex by Affectiva of Waltham, Mass.

In embodiments, the monitored condition is correlated to certain emotional states, thereby, serving as a metric or characteristic of the user. Monitoring may be performed by emotions monitor 104 receiving sensor data from any number of internal or external sensors or devices that observe the user and gather information related to emotions displayed by the user. In embodiments, monitored information includes an emotional state property (e.g., facial expressions, perspiration, voice, body language, etc.) of the user that individually or in combination with other monitored information allow an inference about a current emotional state (e.g., stress) of the user of the computer system.

In embodiments, monitored information is analyzed by security monitor 110 to gain insight into the mental state of the user. Such analysis is generally based on the theory that facial expressions, such as main facial muscle movements that are involved in the expression of an emotion, are innate to humans and are a strong indicator of a person's mental state. A core set of emotions, including happiness, surprise, fear, anger, disgust, and sadness, has been shown to be universally conveyed by facial expressions. In addition to facial expressions, physiological changes, such as a change in the person's respiration or heart rate, typically accompany a given mental state, can be used to aid in the detection of a particular mental state.

In embodiments, the capture of an emotion by emotions monitor 104 serves as a trigger for engaging activity monitor 106 to detect a possible insider threat. In embodiments, activity monitor 106 is any device that monitors human-computer interactions and gathers information about activities undertaken by the user, typically, within a certain time frame of gathering information related to an emotion expressed by the user. Activity monitor 106 serves to enhance the reliability, accuracy (i.e., makes detection less prone to false alarms), and thus usefulness of the mental state analysis that detects deception based on voluntary or involuntary facial expressions of a person interacting with a computer system. The obtained information may be stored locally or remotely for further processing by security monitor 110. Monitored activities may include operations that the user performs using an interface of the computing system, such as a keyboard, mouse, keypad, touch display, etc. In embodiments, activities include manipulating relatively large amounts of data within a relatively short time. It is noted, however, that activities of interest are in no way limited to human-computer interactions or to any specific time frame. For example, activity monitor 106 may collect and use information external to the computing system and even historical data.

In operation, security monitor 110 continuously or periodically receives and processes user information from emotions monitor 104 and activity monitor 106 to decide whether to execute a security policy. In embodiments, the decision may be based on an analysis of the user information that is reviewed for a condition of the user that correlates to one or more predefined emotional states. For example, detection of a voluntarily or involuntarily expressed facial expression associated with a negative emotion, such as anger or stress, occurring within a relatively short predetermined period of time of an activity that is potentially harmful to the company, such as transferring sensitive files, may be used to trigger disabling of software or hardware functions of the computing system.

In embodiments, analysis by emotions monitor 104 employs machine learning concepts to process captured and recorded facial data during the user's interaction with the computer so as to perform real-time analysis using one or more artificial intelligence algorithms that decodes observed facial data into expressed emotions.

In embodiments, processing performed by security monitor 110 to arrive at a decision may take historic information into account and may assign different weights to two or more events to be evaluated. For example, security monitor 110 may comprise rules that trigger a certain system response only for a combination of certain detected emotions that match certain activities to the exclusion of other criteria. As one result, a passive activity (e.g., reading email) in combination with a detected negative emotion (e.g., anger) does not falsely trigger an alarm, thereby, increasing system reliability. In embodiments, individual events that fall below a trigger threshold may be evaluated or reevaluated based on their occurrence within a certain time period.

A person of ordinary skill in the art will appreciate that security monitor 110 may be coupled to a remote server for offsite processing. While embodiments of the invention are discussed in relation to a single user, the inventor envisions that, additionally, data of other users may be collected and processed as part of the analysis.

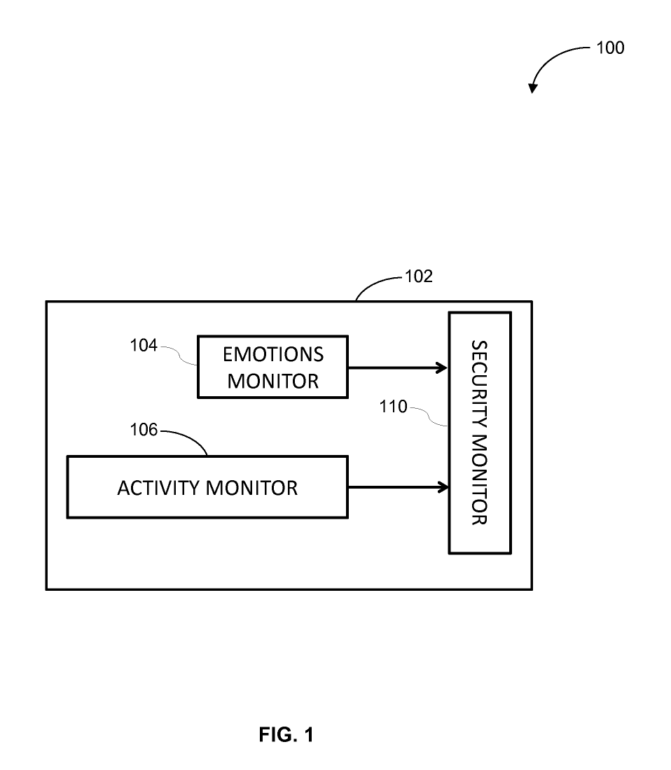

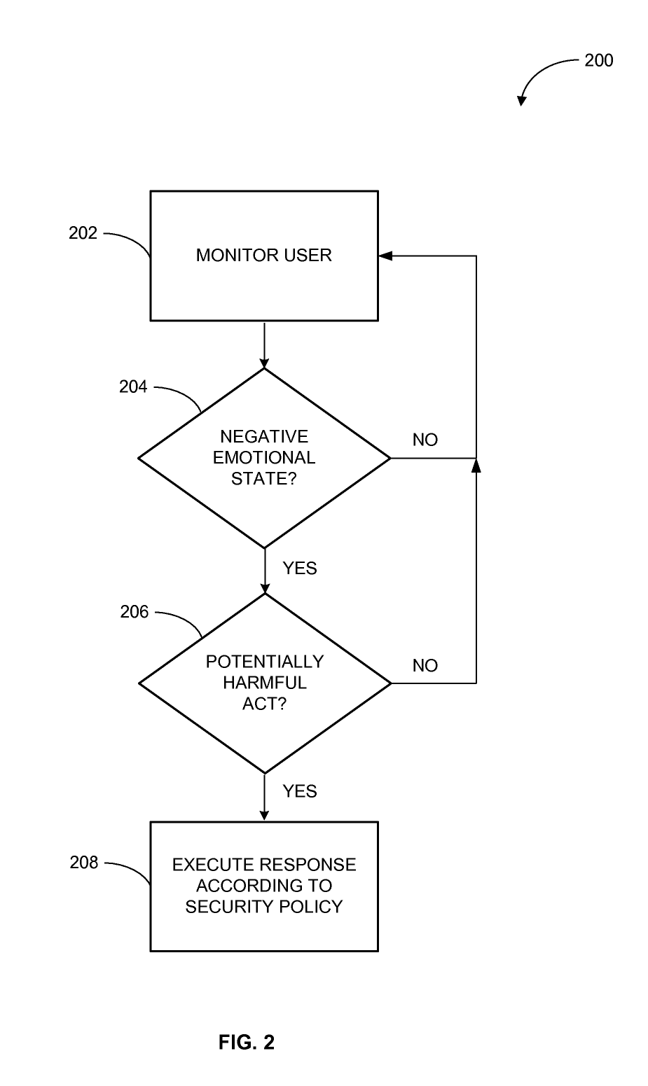

FIG. 2 is as flowchart of an illustrative process for detecting potential security policy violations, according to various embodiments of the invention. In embodiments, the process 200 for detecting potential policy violations begins at step 202, when a user of a computing system is monitored to gather information about the user. In embodiments, the user information includes the user's facial expression and/or a physiological effect or property, such as a measured breathing rate.

In embodiments, at step 204, the user information is analyzed to determine a condition of the user that is indicative of a negative or malicious emotional state of the user. The emotional state may include anger, disgust, resentment, hesitation, stress and any combination thereof. In embodiments, the user information is compared to pre-existing biometric data, for example, for calibration purposes.

In embodiments, if the condition is detected, at step 206, one or more potentially harmful user activities (e.g., manipulating or deleting sensitive files, installing unapproved software) are monitored and/or queried. Activities may include activities that are unrelated to an activity performed on the computing system itself, for example, entering of a particular room with an anomalous frequency or at unusual times. In embodiments, activities include activities or two or more persons. For example, the potentially harmful act may be conducted by a person other than the user displaying the negative emotional state at step 204.

Finally, at step 208, in response to determining the condition and one or more actions that the user has undertaken within a predetermined time window of the detected condition that taken together may be indicative of a policy violation or a security breach, a response is executed according to a security policy. One appropriate response may be to send a notice in the form of an email alert to a system administrator. Other responses may include, for example, displaying a dialog box on a monitor that requires additional justification and/or verification for performing a particular action, temporarily disabling parts of or all of the computing system according to the security policy, and the like.

In embodiments, even if a negative or malicious emotional state of the user is detected, in the absence of a potentially harmful user activity, the response is not executed and vice versa. Instead, the process resumes with monitoring the user at step 202.

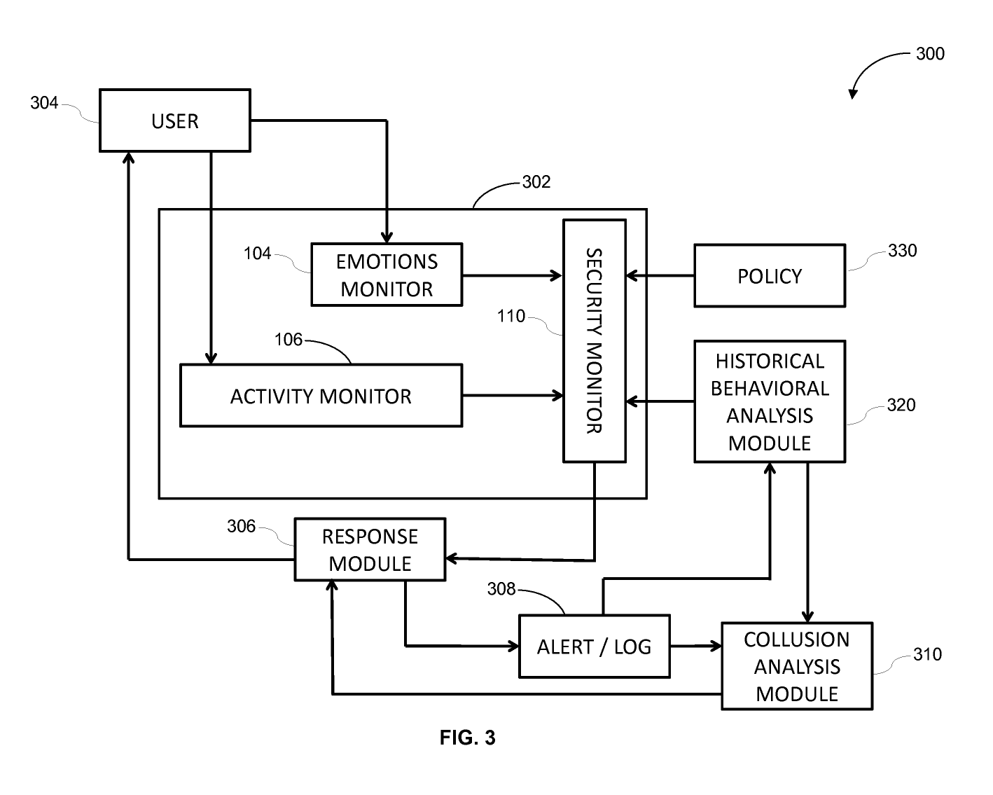

FIG. 3 is an exemplary block diagram of a security system to detect potential security policy violations, according to various embodiments of the invention. For clarity, components similar to those shown in FIG. 1 are labeled in the same manner. For purpose of brevity, a description or their function is not repeated here.

In embodiments, security system 300 comprises security device 302, historical behavioral analysis module 320, response module 306, collusion analysis module 310, and policy module. In embodiments, emotions monitor 104 is coupled to receive user data related to user 304 accessing a computing system that is coupled to security device 302. It shall be understood that the computing system may include, at least, any of the elements shown in security system 300. In embodiments, all elements shown in security system 300 operate on the same computing system.

Emotions monitor 104 is communicatively coupled to one or more sensors that receive data about the user that can be used to infer an emotional state of the user. For example, in embodiments, emotions monitor 104 receives images of the user via one or more image capturing device, such as a camera, and uses the image data to detect facial expressions, including facial microexpressions, to infer an emotional state. In embodiments, emotions monitor 104 receives sensor data relates to emotional state property displayed by user 304 to aid in inferring the emotional state.

Historical behavioral analysis module 320 typically stores and analyzes historical data, including captured and recorded facial data, that may or may not be available in pre-processed format. Historical data may be based on events that are unrelated to the interaction by user 304 with the computing system, such as a confidentiality level of data accessed by user 304, the number and frequency of activities pre-classified as suspicious or anomalous (e.g., searching for, accessing, or manipulating sensitive files), and external information events (e.g., biometric data, including walking habits in and around the premises housing the computing system) that may occur at different times.

In embodiments, the historical behavioral analysis module 320 saves raw data from one or more sensors for subsequent analysis or use. For example, the data may be reviewed in cases where there is a desire to confirm that the sensors were providing data consistent with the recorded emotion.

Collusion analysis module 310 is configured to store or analyze information related to user 304 and one or more other people. In embodiments, collusion analysis module 310 may receive stored emotions and/or actions data from historical behavioral analysis module 320, data from the security monitor 110, may receive data directly from the sensors, or any combination thereof.

In embodiments, activities involving a plurality of persons are analyzed to discover a potential collusion between two or more actors or groups of individuals. For example, one person's potentially harmful act may be correlated to the conduct or detected emotional state of another person. Detection of collusion might be guided by information indicating that two individuals know each other (e.g., are in the same building or organization, or have exchanged email).

In operation, security monitor 110 processes information about user 304 to determine a condition representative of the emotional state. Upon determining a predefined condition, security monitor 110 initiates the execution of a response via response module 306 in accordance with security policy 330.

In embodiments, as part of determining an emotional state, security monitor 110 accesses and utilizes historic stored and/or analyzed data from the historical behavioral analysis module 320 to evaluate interactions by user 304 with the computing system. Generally, any potentially relevant event may be taken into consideration. In embodiments, security monitor 110 assigns different weights to two or more pre-identified historic events when evaluating their importance in connection with activities undertaken by user 304, including monitored human-computer interactions. In embodiments, historical data is used to compare and detect differences between historic data and more recent events and/or user activity.

Collusion analysis module 310 may perform one or more of functions of storing, analyzing, and providing information related to user 304 and at least another person that is not necessarily a user of the computing system. Finally, response module 306 executes security policy 330 in response to predicting or detecting a policy violation, as previously mentioned. In embodiments, a stimulus may be generated for the purpose of triggering a user response in the form of a physiological effect or property that is indicative of an emotional state of the user and evaluating the user response. For example, the stimulus may include the display of a dialog box on a monitor that notifies the user about being monitored.

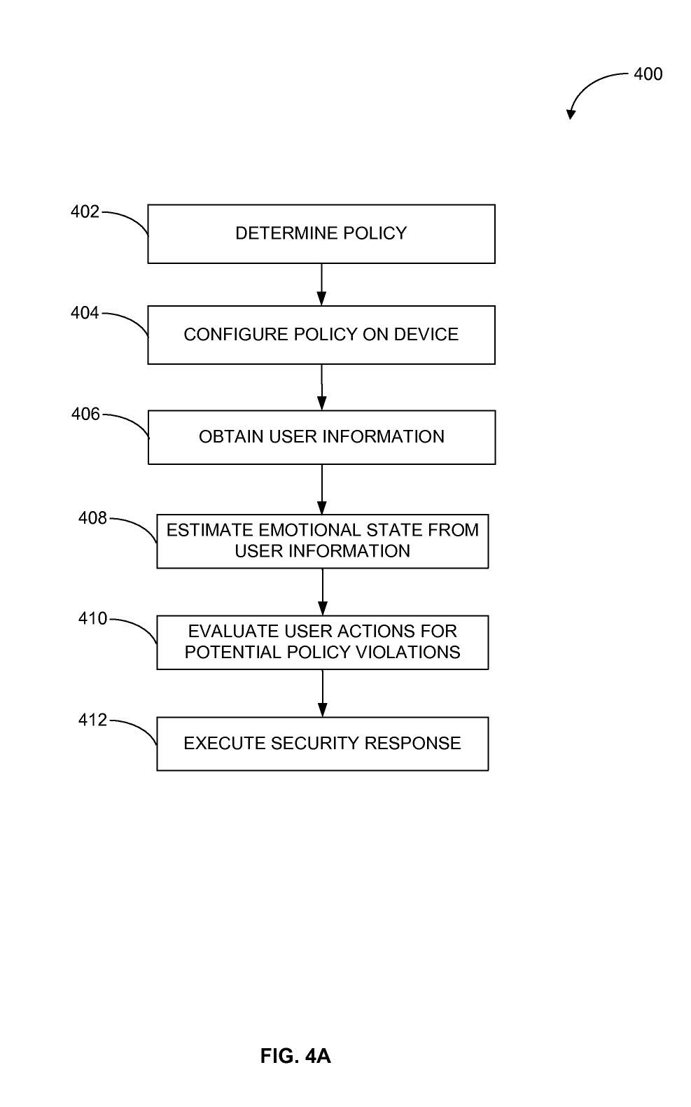

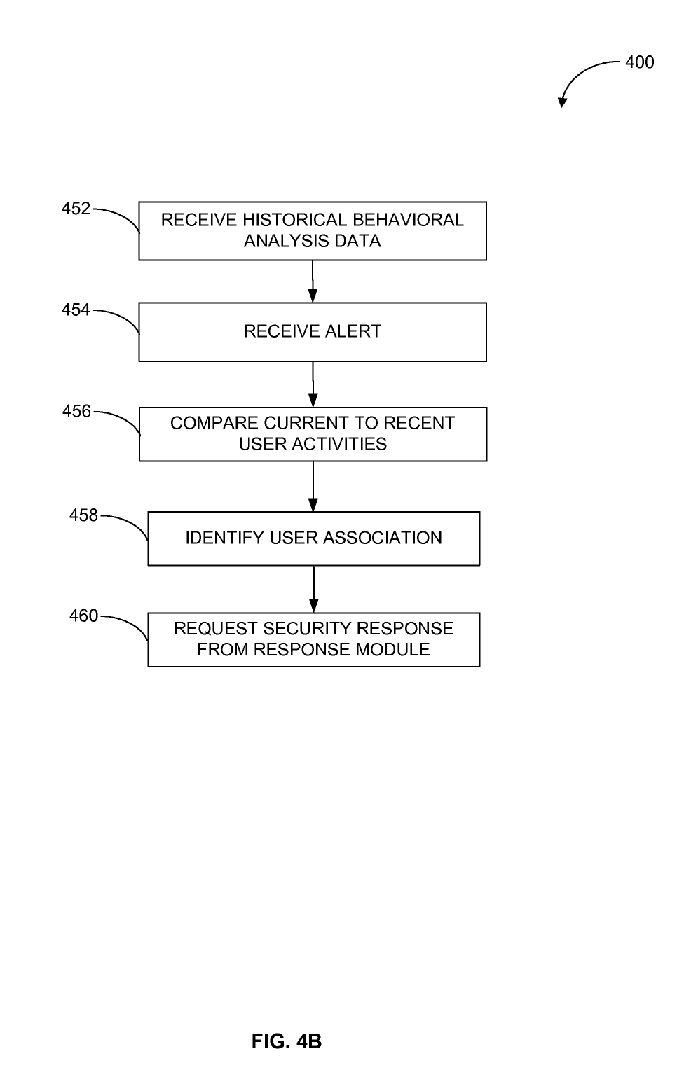

FIG. 4A is as flowchart of an illustrative process for applying a security response to detecting a potential security policy violation, according to various embodiments of the invention. The process 400 for applying the policy begins at step 402, when a policy is determined based on a set of rules that may be established, for example, by a corporate entity interested in protecting its proprietary information that is stored on a computing system.

At step 404, the policy is implemented on a device that is internal or external to the part of the computing system that is accessed by a user.

At step 406, the user is monitored and information about the user is obtained. User information may include facial and physiological data and may be compared to biometric data. Monitoring of the user may be performed by cameras or other sensors coupled to an emotions monitor. The emotions monitor may communicate this information to a historical behavioral analysis module or a collusion analysis module.

At step 408, the user information is analyzed, for example by a security monitor, to estimate or determine a condition indicative of an emotional state of the user, such as attention, disgust, excitement, hesitation, stress and the like.

At step 410, an action undertaken by the user within a predetermined time window of the estimated or detected condition is reviewed, for example by a security monitor, to determine potential policy violations.

At step 412, a security response, such as an alert, is executed, for example by a response module, in response to detecting an actual or potential policy violation or security breach.

It will be appreciated by those skilled in the art that fewer or additional steps may be incorporated with the steps illustrated herein without departing from the scope of the invention. No particular order is implied by the arrangement of blocks within the flowchart or the description herein.

FIG. 4B is as flowchart of an illustrative process for applying a security response to detecting potential collusion activity among users, according to various embodiments of the invention. Process 450 for applying a security policy begins at step 452, when a collusion analysis module receives data from a historical behavioral analysis data module. The data may comprise a history of activities and associated emotions for two of more users as well as any previous alerts.

At step 456, e.g., in response to receiving an alert at step 454, a current activity for a current user is evaluated in light of recent activities from one or more other users, for example by a collusion analysis module. In embodiments, the users may be involved in an unusual or unexpected activity while being identified as having a particular emotional state (e.g., looking stressed, fearful, angry, guilty, etc.). In embodiments, while either activity alone may not be sufficient to justify the application of a security response, such as alerting IT security staff, when combined activities may present a threat that warrants heighted attention. For example, user A might have access to a document X, but not to document Y, while user B does have access to document Y but not to document X, wherein an alert would be triggered only if both documents are accessed by the same person. If it is found that both users within a relatively short period of time (e.g., 24 hrs) downloaded both files and at least one of the users exhibited careering negative emotions, this may be sufficient to justify and trigger an alert.

At step 458, if an association between the two users can be identified from additional data sources, such as having emailed each other, working in the same building, etc., that indicates collusion, then, at step 460, an appropriate security response by the response module is requested.

Aspects of the present patent document are directed to information handling systems. For purposes of this disclosure, an information handling system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

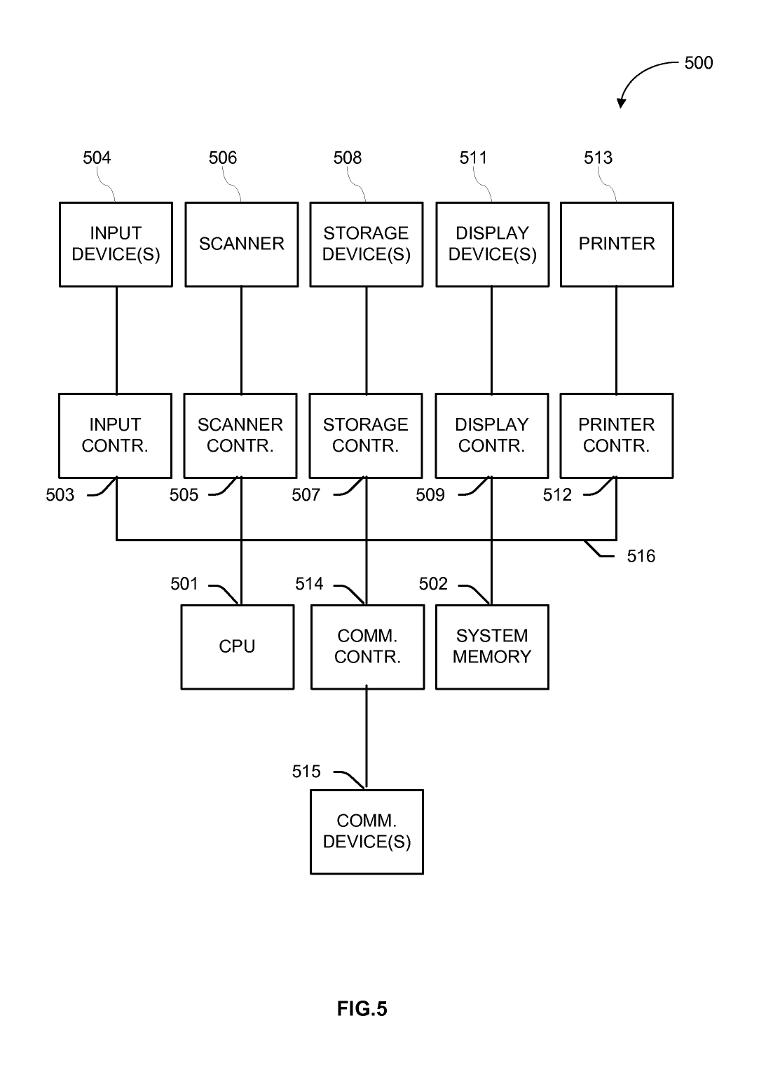

FIG. 5 depicts a simplified block diagram of an information handling system comprising a security system, according to various embodiments of the present invention. It will be understood that the functionalities shown for system 500 may operate to support various embodiments of an information handling system—although it shall be understood that an information handling system may be differently configured and include different components. As illustrated in FIG. 5, system 500 includes a central processing unit (CPU) 501 that provides computing resources and controls the computer. CPU 501 may be implemented with a microprocessor or the like, and may also include a graphics processor and/or a floating point coprocessor for mathematical computations. System 500 may also include a system memory 502, which may be in the form of random-access memory (RAM) and read-only memory (ROM).

A number of controllers and peripheral devices may also be provided, as shown in FIG. 5. An input controller 503 represents an interface to various input device(s) 504, such as a keyboard, mouse, or stylus. There may also be a scanner controller 505, which communicates with a scanner 506. System 500 may also include a storage controller 507 for interfacing with one or more storage devices 508 each of which includes a storage medium such as magnetic tape or disk, or an optical medium that might be used to record programs of instructions for operating systems, utilities and applications which may include embodiments of programs that implement various aspects of the present invention. Storage device(s) 508 may also be used to store processed data or data to be processed in accordance with the invention. System 500 may also include a display controller 509 for providing an interface to a display device 511, which may be a cathode ray tube (CRT), a thin film transistor (TFT) display, or other type of display. The computing system 500 may also include a printer controller 512 for communicating with a printer 513. A communications controller 514 may interface with one or more communication devices 515, which enables system 500 to connect to remote devices through any of a variety of networks including the Internet, an Ethernet cloud, an FCoE/DCB cloud, a local area network (LAN), a wide area network (WAN), a storage area network (SAN) or through any suitable electromagnetic carrier signals including infrared signals.

In the illustrated system, all major system components may connect to a bus 516, which may represent more than one physical bus. However, various system components may or may not be in physical proximity to one another. For example, input data and/or output data may be remotely transmitted from one physical location to another. In addition, programs that implement various aspects of this invention may be accessed from a remote location (e.g., a server) over a network. Such data and/or programs may be conveyed through any of a variety of machine-readable medium including, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices.

Embodiments of the present invention may be encoded upon one or more non-transitory computer-readable media with instructions for one or more processors or processing units to cause steps to be performed. It shall be noted that the one or more non-transitory computer-readable media shall include volatile and non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present invention may further relate to computer products with a non-transitory, tangible computer-readable medium that have computer code thereon for performing various computer-implemented operations. The media and computer code may be those specially designed and constructed for the purposes of the present invention, or they may be of the kind known or available to those having skill in the relevant arts. Examples of tangible computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter. Embodiments of the present invention may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present invention. One skilled in the art will also recognize that a number of the elements described above may be physically and/or functionally separated into sub-modules or combined together.

It will be appreciated to those skilled in the art that the preceding examples and embodiment are exemplary and not limiting to the scope of the present invention. It is intended that all permutations, enhancements, equivalents, combinations, and improvements thereto that are apparent to those skilled in the art upon a reading of the specification and a study of the drawings are included within the true spirit and scope of the present invention.

I claim:

1. A security system to apply a security response to a potential security policy violation, the system comprising:
a user monitoring device that receives sensor data from one or more sensors that monitor a user of a computing system to gather emotion-related information, and that outputs an inferred emotional state of the user based at least in part on the gathered emotion-related information;
an activity monitoring device that monitors activities undertaken on a computer system by one or more persons and that categorizes one or more activities undertaken within a predetermined time period of the inferred emotional state; and
a security monitor coupled to at least one of the user monitoring device and the activity monitoring device, the security monitor executes a security policy based at least in part on the inferred emotional state and a categorized activity.

2. The security system according to claim 1, wherein the one or more activities are categorized in response to determining that the inferred emotional state of the user is a negative emotional state.

3. The security system according to claim 2, wherein the one or more activities are categorized into an active category or a passive category.

4. The security system according to claim 3, wherein the security monitor executes the policy in response to the inferred emotional state of the user being a negative emotional state and the categorized activity being in the active category.

5. The security system according to claim 1, wherein the security policy comprises:
examining the one or more activities in more detail; and
responsive to the action being potentially harmful, executing an additional security policy.

6. The security system according to claim 1, wherein the one or more sensors monitor one or more emotional state properties of the user, the one or more emotional state properties being used to assess the inferred emotional state of the user.

7. The security system according to claim 1, further comprising a collusion analysis module coupled to the security monitor, the collusion analysis module correlates the activity of one or more persons and the inferred emotional state of the user to detect a potential collusion.

8. The security system according to claim 1, wherein the one or more activities are categorized in response to the inferred emotional state of the user being a negative emotional state and, wherein the security monitor executes the security policy in response to the categorized activity being potentially harmful.

9. The security system according to claim 6, wherein the security monitor executes the security policy in response to receiving both negative emotional state information from the user monitoring device and potentially harmful activity information from the activity monitoring device.

10. The security system according to claim 1, wherein the security monitor is coupled to receive from a historic behavior analysis module secondary information associated with an event other than a present interaction by the user of the computing system.

11. A method to apply a security response to a potential security policy violation, the method comprising:
monitoring a user of a computing system to gather user information;
analyzing the user information to determine a condition of the user, the condition correlating to a predefined emotional state;
responsive to detecting the condition, reviewing one or more actions undertaken by a user on the computing system within a predetermined time period of the condition; and
based on at least the one or more actions, executing a response according to a security policy.

12. The method according to claim 11, wherein monitoring comprises determining at least one of a facial expression and a physical property for inferring an emotional state of the user.

13. The method according to claim 11, wherein executing the security policy comprises one of displaying a dialog box on a monitor, sending a notice, triggering additional monitoring of the user, and at least partially disabling the computing system.

14. The method according to claim 11, wherein the predetermined time period encompasses a historic event other than a present interaction by the user of the computing system.

15. The method according to claim 11, further comprising evaluating events exceeding a trigger threshold based on an occurrence of the events within the predetermined time period.

16. The method according to claim 11, further comprising exposing the user to a stimulus and, in response thereto, evaluating the user information.

17. A security device to detect a potential security policy violation, the security device comprising:
an emotion and activity processing module coupled to receive and analyze sensor data associated with an emotional state of a user of a computing system to infer an emotional state of the user based at least in part on the sensor data;
the emotion and activity processing module further coupled to receive data related to an activity of the user, the activity having occurred within a predetermined time period of receipt of the sensor data and being categorized as active or passive; and
security monitor coupled to receive and analyze data from the emotion and activity processing module to determine a potential security policy violation.

18. The security device according to claim 17, wherein the emotion and activity processing module is configured to monitor a user interface activity.

19. The security device according to claim 18, wherein the user interface activity comprises an activity that is pre-classified as being suspicious.

20. The security device according to claim 17, wherein the emotion and activity processing module applies emotions information to a trained set of predetermined properties to infer the emotional state of the user.
